(19) United States
(12) Patent Application Publication
(10) Pub. No.: US 2023/0001805 A1
(43) Pub. Date: Jan. 5, 2023

(54) SERVER

(71) Applicant: TOYOTA JIDOSHA KABUSHIKI KAISHA, Aichi-ken (JP)

(72) Inventors: Daiki YOKOYAMA, Gotemba-shi (JP); Toshiya HASHIMOTO, Miyoshi-shi (JP); Shuntaro OKAZAKI, Sunto-gun (JP); Shogo TSUGE, Fuji-shi (JP); Kazuhisa MATSUDA, Sunto-gun (JP)

(21) Appl. No.: 17/842,793

(22) Filed: Jun. 17, 2022

(30) Foreign Application Priority Data
Jun. 30, 2021 (JP) 2021-109507

(51) Int. Cl. B60L 53/126; B60L 53/30; B60L 53/62; B60L 53/66; H02J 50/12; H02J 50/80; H02J 50/70

(52) U.S. Cl. CPC B60L 53/126; B60L 53/305; B60L 53/62; B60L 53/66; H02J 50/12; H02J 50/80; H02J 50/70; B60L 2270/32

(57) ABSTRACT

A server includes: a communicator configured to communicate with a plurality of ground power supply devices configured to transmit electric power to a vehicle in a non-contact manner; a storage configured to store at least information on a total power supply amount within a predetermined period of the ground power supply devices; and one or more processors configured to, when a total power supply amount within a predetermined period of one ground power supply device among the ground power supply devices is equal to or greater than a determination threshold value set based on data of the total power supply amount within the predetermined period of the ground power supply devices, determine that stealing or leakage of electricity has occurred in the one ground power supply device.

### CROSS-REFERENCE TO RELATED APPLICATION

This application claims priority to Japanese Patent Application No. 2021-109507 filed on Jun. 30, 2021, incorporated herein by reference in its entirety.

### BACKGROUND

### 1. Technical Field

The present disclosure relates to a server.

### 2. Description of Related Art

There is known a non-contact power supply system that transmits electric power from a ground power supply device provided on ground to a traveling vehicle in a non-contact manner by using a transmission method, such as magnetic field coupling (electromagnetic induction), electric field coupling, magnetic field resonance coupling (magnetic field resonance), and electromagnetic field resonance coupling (electromagnetic field resonance) (see Japanese Unexamined Patent Application Publication No. 2018-157686 (JP 2018-157686 A)).

### SUMMARY

The above non-contact power supply system does not have means for detecting stealing or leakage of electricity in the ground power supply device, and therefore, there is a problem that it is difficult to detect the stealing or leakage of electricity.

The present disclosure provides a technique to detect stealing or leakage of electricity in a ground power supply device.

An aspect of the present disclosure relates to a server. The server includes: a communicator; a storage; and one or more processors. The communicator is configured to communicate with a plurality of ground power supply devices configured to transmit electric power to a vehicle in a non-contact manner. The storage is configured to store at least information on a total power supply amount within a predetermined period of the ground power supply devices. The one or more processors are configured to, when a total power supply amount of one ground power supply device is equal to or greater than a determination threshold value set based on data, determine that stealing or leakage of electricity has occurred in the one ground power supply device. The total power supply amount of the one ground power supply device is a total power supply amount within a predetermined period of the one ground power supply device among the ground power supply devices and is received from the one ground power supply device via the communicator. The data is data of the total power supply amount within the predetermined period of the ground power supply devices and is stored in the storage.

In the aspect of the present disclosure, the one or more processors may be configured to set the determination threshold value by a statistical method using the data.

In the aspect of the present disclosure, the one or more processors may be configured to set the determination threshold value by the statistical method using first data, out of the data. The first data may be data of a total power supply amount within a predetermined period of the ground power supply device that exists within a range in which the vehicle receiving power supply from the one ground power supply device is highly likely to travel.

In the aspect of the present disclosure, the ground power supply device that exists within the range in which the vehicle receiving the power supply from the one ground power supply device is highly likely to travel may be a ground power supply device continuously disposed along a traveling lane in which the one ground power supply device is installed.

In the aspect of the present disclosure, the one or more processors may be configured to, when determination is made that the stealing or leakage of electricity has occurred in the one ground power supply device, instruct the one ground power supply device to prohibit power supply via the communicator.

In the aspect of the present disclosure, the communicator may be configured to communicate with an external related organization, and the one or more processors may be configured to, when determination is made that the stealing or leakage of electricity has occurred in the one ground power supply device, notify the external related organization that the stealing or leakage of electricity has occurred in the one ground power supply device via the communicator.

According to the aspect of the present disclosure, it is possible to detect the stealing or leakage of electricity from the ground power supply device.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic configuration diagram of a non-contact power supply system;

FIG. 2 is a diagram illustrating a detailed configuration of a ground power supply device and a vehicle;

FIG. 3 is a schematic configuration diagram of a power transmission controller and equipment connected to the power transmission controller;

FIG. 4 is a schematic configuration diagram of a vehicle controller and equipment connected to the vehicle controller;

FIG. 5 is a flowchart illustrating contents of processing executed between each ground power supply device and a server in order to detect stealing or leakage of electricity in each ground power supply device; and

FIG. 6 is a graph illustrating an example of a method for setting a determination threshold value.

### DETAILED DESCRIPTION OF EMBODIMENTS

Hereinafter, embodiments will be described in detail with reference to the drawings. In the following description, similar components are denoted by the same reference numerals.

### Description of Non-Contact Power Supply System

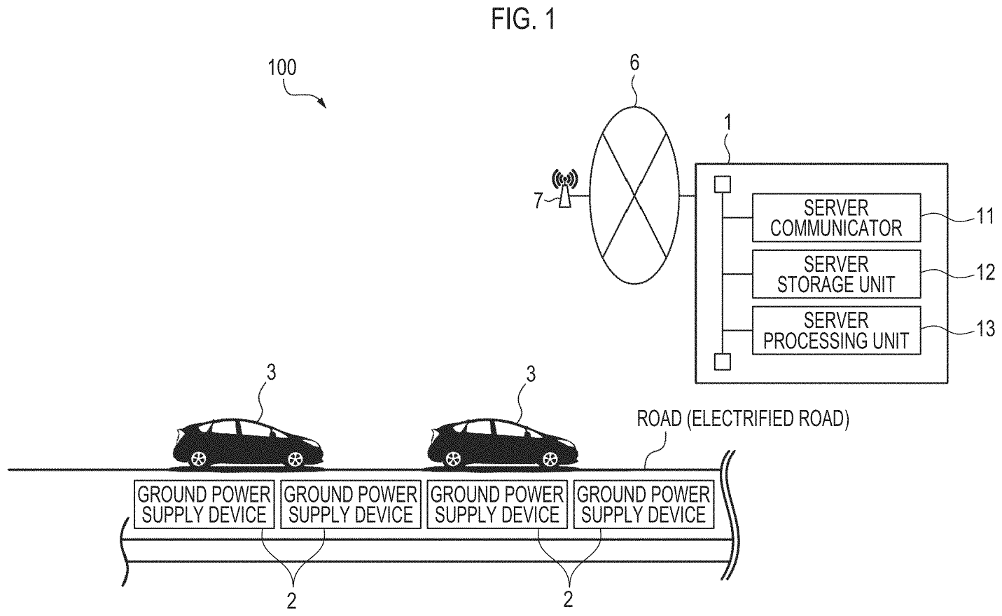

FIG. 1 is a schematic configuration diagram of a non-contact power supply system 100 according to an embodiment of the present disclosure.

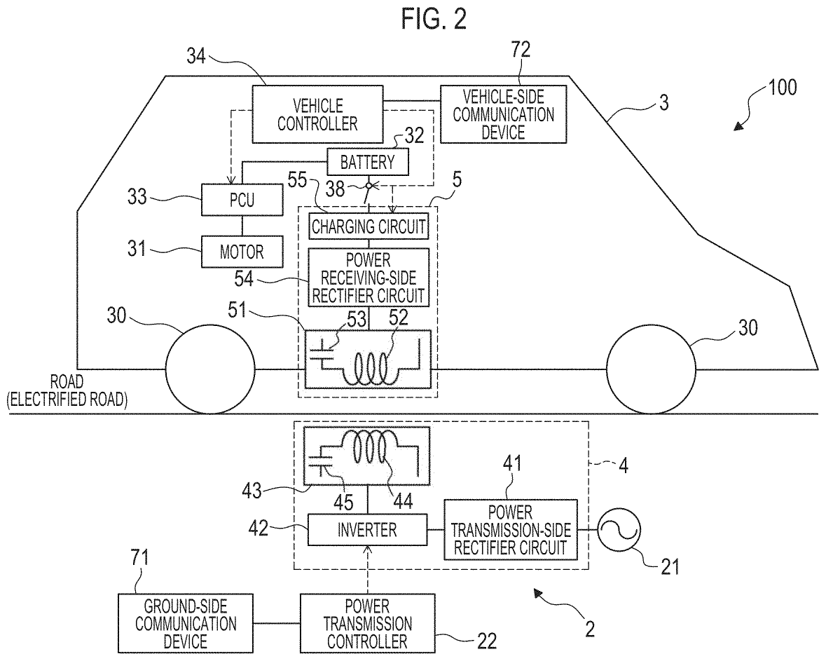

The non-contact power supply system 100 according to the present embodiment includes a server 1, a plurality of ground power supply devices 2 continuously installed at predetermined intervals along a road, and a plurality of vehicles 3 each of which is mounted with a power receiving device 5 (see FIG. 2) for receiving electric power wirelessly transmitted from the ground power supply device 2, and performs non-contact electric power transmission from the ground power supply device 2 to the vehicle 3 by magnetic field resonance coupling (magnetic field resonance). In particular, in the present embodiment, the non-contact power supply system 100 performs non-contact electric power transmission from the ground power supply device 2 to the vehicle 3 when the vehicle 3 is traveling. Therefore, the ground power supply device 2 transmits electric power to the vehicle 3 in a non-contact manner when the vehicle 3 is traveling, and the vehicle 3 receives electric power from the ground power supply device 2 in a non-contact manner when the vehicle 3 is traveling.

In the present specification, the term “traveling” means a state in which the vehicle is located on the road for traveling. Therefore, the term “traveling” includes a state in which the vehicle is stopped on the road due to, for example, waiting for traffic light to change, as well as a state in which the vehicle is actually traveling at any speed greater than zero. On the other hand, even though the vehicle is located on the road, when the vehicle is parked and stopped, for example, the state is not included in the traveling. In the following description, the road on which the ground power supply device 2 is installed is referred to as an “electrified road” as needed.

The server 1 includes a server communicator 11, a server storage 12, and a server processing unit 13.

The server communicator 11 has a communication interface circuit for connecting the server 1 to a network 6 via, for example, a gateway. The server 1 communicates with the ground power supply device 2 and the vehicle 3 via the server communicator 11, and also communicates with an external related organization (for example, a maintenance company of the ground power supply device 2 or a public organization, such as the police) as needed.

The server storage 12 has a storage medium, such as a hard disk drive (HDD), an optical recording medium, and a semiconductor memory, and stores various computer programs, data, and the like used for processing in the server processing unit 13.

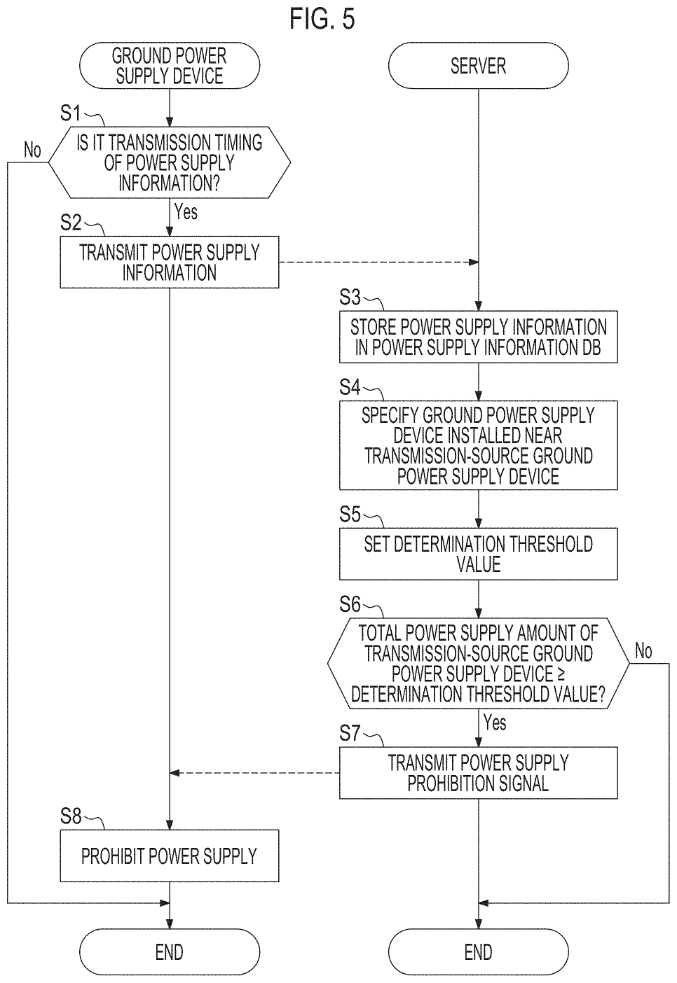

The server processing unit 13 has one or a plurality of central processing units ((CPUs); hereinafter, referred to as a “CPU”) and peripheral circuits thereof. The server processing unit 13 executes various computer programs stored in the server storage 12 to comprehensively control the overall operation of the server 1, and is, for example, one or more processors. The processing executed by the server processing unit 13, that is, the server 1 will be described below with reference to FIG. 5 and the like.

FIG. 2 is a diagram illustrating a detailed configuration of the ground power supply device 2 and the vehicle 3 according to the present embodiment.

As shown in FIG. 2, the ground power supply device 2 includes a ground-side communication device 71, a power transmission device 4, an electric power source 21, and a power transmission controller 22. The ground-side communication device 71, the electric power source 21, and the power transmission controller 22 may be embedded in the road, or may be disposed in a place (including the ground) other than the road.

The ground-side communication device 71 is configured to communicate with the server 1 and the vehicle 3. In the present embodiment, the ground-side communication device 71 accesses a wireless base station 7 (see FIG. 1) connected to the network 6 (see FIG. 1) via a gateway (not shown) or the like, thereby being connected to the network 6 via the wireless base station 7. With this, wireless communication is performed between the ground-side communication device 71 and the server 1, and for example, various types of information needed for performing non-contact power supply to the vehicle 3 are exchanged.

The ground-side communication device 71 directly performs wireless communication with a vehicle-side communication device 72 mounted on each vehicle 3 using a predetermined wireless communication line, and receives an approach signal transmitted from the vehicle-side communication device 72. The approach signal is a signal for notifying that the vehicle 3 is approaching the ground power supply device 2, and is a signal for urging the ground power supply device 2 that has received the approach signal via the ground-side communication device 71, to prepare for power transmission.

The electric power source 21 supplies electric power to the power transmission device 4. The electric power source 21 is, for example, a commercial alternating-current electric power source that supplies single-phase alternating-current electric power. The electric power source 21 may be another alternating-current electric power source that supplies three-phase alternating-current electric power, or may be a direct-current electric power source, such as a fuel cell.

The power transmission device 4 transmits the electric power supplied from the electric power source 21 to the vehicle 3. The power transmission device 4 has a power transmission-side rectifier circuit 41, an inverter 42, and a power transmission-side resonance circuit 43. In the power transmission device 4, alternating-current electric power supplied from the electric power source 21 is rectified in the power transmission-side rectifier circuit 41 and converted into a direct current, and this direct current is converted into alternating-current electric power in the inverter 42, and this alternating-current electric power is supplied to the power transmission-side resonance circuit 43.

The power transmission-side rectifier circuit 41 is electrically connected to the electric power source 21 and the inverter 42. The power transmission-side rectifier circuit 41 rectifies alternating-current electric power supplied from the electric power source 21 and converts the alternating-current electric power into direct-current electric power, and supplies the direct-current electric power to the inverter 42. The power transmission-side rectifier circuit 41 is, for example, an AC/DC converter.

The inverter 42 is electrically connected to the power transmission-side rectifier circuit 41 and the power transmission-side resonance circuit 43. The inverter 42 converts the direct-current electric power supplied from the power transmission-side rectifier circuit 41 into alternating-current electric power (high-frequency electric power) having a frequency higher than a frequency of the alternating-current electric power of the electric power source 21, and supplies the high-frequency electric power to the power transmission-side resonance circuit 43.

The power transmission-side resonance circuit 43 has a resonator formed of a coil 44 and a capacitor 45. Various parameters of the coil 44 and the capacitor 45 (outer diameter and inner diameter of the coil 44, number of windings of the coil 44, capacitance of the capacitor 45, and the like) are determined such that a resonance frequency of the power transmission-side resonance circuit 43 becomes a predetermined set value. The predetermined set value is, for example, 10 kHz to 100 GHz, and may be 85 kHz as defined by a standard of SAE TIR J2954 as a frequency band for non-contact electric power transmission.

The power transmission-side resonance circuit 43 is disposed at the center of a lane through which the vehicle 3 passes such that the center of the coil 44 is located at the center of the lane. When the high-frequency electric power supplied from the inverter 42 is applied to the power transmission-side resonance circuit 43, the power transmission-side resonance circuit 43 generates an alternating-current magnetic field for power transmission. When the electric power source 21 is a direct-current electric power source, the power transmission-side rectifier circuit 41 may be omitted.

The power transmission controller 22 is, for example, a general-purpose computer, and performs various controls of the ground power supply device 2. For example, the power transmission controller 22 is electrically connected to the inverter 42 of the power transmission device 4 and controls the inverter 42 to control the electric power transmission by the power transmission device 4. In addition, the power transmission controller 22 communicates with the server 1 and the vehicle 3 via the ground-side communication device 71. The power transmission controller 22 can directly communicate with the vehicle 3 via the ground-side communication device 71, or can indirectly communicate with the vehicle 3 via the server 1 from the ground-side communication device 71.

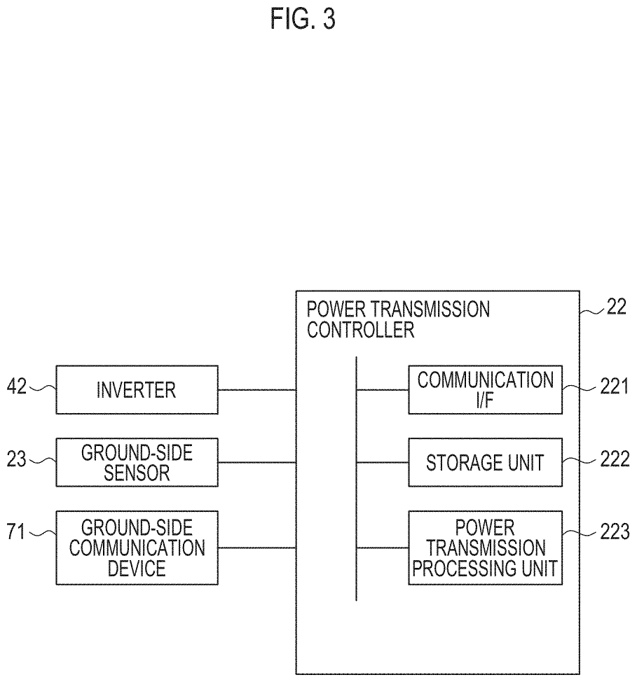

FIG. 3 is a schematic configuration diagram of the power transmission controller 22 and equipment connected to the power transmission controller 22.

The power transmission controller 22 includes a communication interface 221, a storage 222, and a power transmission processing unit 223. The communication interface 221, the storage 222 and the power transmission processing unit 223 are connected to one another via a signal line.

The communication interface 221 has an interface circuit for connecting the power transmission controller 22 to various kinds of equipment (for example, the inverter 42, the ground-side communication device 71, and a ground-side sensor 23 described below) constituting the ground power supply device 2. The power transmission controller 22 communicates with the various kinds of equipment constituting the ground power supply device 2 via the communication interface 221.

The storage 222 has a storage medium, such as an HDD, an optical recording medium, and a semiconductor memory, and stores various computer programs, data, and the like used for processing in the power transmission processing unit 223.

The power transmission processing unit 223 has one or a plurality of CPUs and peripheral circuits thereof. The power transmission processing unit 223 executes various computer programs stored in the storage 222 to comprehensively control the overall operation of the ground power supply device 2, and is, for example, one or more processors. For example, when the approach signal is received via the ground-side communication device 71, the power transmission processing unit 223, that is, the power transmission controller 22 controls the ground power supply device 2 such that electric power can be transmitted to the vehicle 3 when the vehicle 3 passes.

The ground-side sensor 23 is connected to the power transmission controller 22. The ground-side sensor 23 includes, for example, a power transmission device current sensor that detects a current that flows through various kinds of equipment (in particular, the power transmission-side resonance circuit 43, the inverter 42, and the power transmission-side rectifier circuit 41) of the power transmission device 4, a power transmission device voltage sensor that detects a voltage applied to various kinds of equipment of the power transmission device 4, a power transmission device temperature sensor that detects a temperature of various kinds of equipment of the power transmission device 4, a foreign substance sensor that detects foreign matter on the road in which the power transmission device 4 is embedded, and a biosensor that detects a living organism on the road in which the power transmission device 4 is embedded. The output of the ground-side sensor 23 is input to the power transmission controller 22.

Returning to FIG. 2, the vehicle 3 has the vehicle-side communication device 72, the power receiving device 5, a motor 31, a battery 32, a power control unit (hereinafter, referred to as a “PCU”) 33, and a vehicle controller 34. Although the vehicle 3 according to the present embodiment is an electrified vehicle (battery electric vehicle (BEV)) that uses solely the battery 32 as a power source, the vehicle 3 may be a so-called hybrid vehicle (hybrid electric vehicle (HEV) or plug-in hybrid electric vehicle (PHEV)) that has a power source, such as an internal combustion engine, in addition to the battery 32, and the type thereof is not particularly limited.

The vehicle-side communication device 72 is configured to communicate with the server 1 and the ground power supply device 2. In the present embodiment, the vehicle-side communication device 72 accesses the wireless base station 7 (see FIG. 1) connected to the network 6 (see FIG. 1) via a gateway (not shown) or the like, thereby being connected to the network 6 via the wireless base station 7. With this, wireless communication is performed between the vehicle-side communication device 72 and the server 1, and for example, various types of information needed for receiving non-contact power supply from the ground power supply device 2 are exchanged. In this case, information is exchanged between the vehicle 3 and the ground power supply device 2 via the server 1.

The vehicle-side communication device 72 directly communicates with the ground-side communication device 71 of each ground power supply device 2 using a predetermined wireless communication line, and transmits the above-described approach signal to each ground power supply device 2.

The motor 31 is, for example, an alternating-current synchronous motor, and functions as an electric motor and a generator. When the motor 31 functions as an electric motor, the motor 31 is driven by using electric power stored in the battery 32 as a power source. The output of the motor 31 is transmitted to wheels 30 via a reduction gear and axles. On the other hand, when a speed of the vehicle 3 is reduced, the motor 31 is driven by rotation of the wheels 30, and the motor 31 functions as a generator to generate regenerative electric power.

The battery 32 is a rechargeable secondary battery, and is formed of, for example, a lithium ion battery or a nickel hydrogen battery. The battery 32 stores electric power needed for traveling of the vehicle 3 (for example, drive electric power of the motor 31). When electric power received by the power receiving device 5 from the power transmission device 4 is supplied to the battery 32, the battery 32 is charged. In addition, when the regenerative electric power generated by the motor 31 is supplied to the battery 32, the battery 32 is charged. When the battery 32 is charged, a state of charge (SOC) of the battery 32 is restored. The battery 32 may be charged by an external electric power source other than the ground power supply device 2 via a charging port provided in the vehicle 3.

The PCU 33 is electrically connected to the battery 32 and the motor 31. The PCU 33 has an inverter, a boost converter, and a DC/DC converter. The inverter converts direct-current electric power supplied from the battery 32 into alternating-current electric power, and supplies the alternating-current electric power to the motor 31. On the other hand, the inverter converts alternating-current electric power (regenerative electric power) generated by the motor 31 into direct-current electric power, and supplies the direct-current electric power to the battery 32. The boost converter boosts a voltage of the battery 32 as needed when the electric power stored in the battery 32 is supplied to the motor 31. The DC/DC converter steps down the voltage of the battery 32 when the electric power stored in the battery 32 is supplied to electronic equipment, such as a headlight.

The power receiving device 5 receives electric power from the power transmission device 4 and supplies the received electric power to the battery 32. The power receiving device 5 has a power receiving-side resonance circuit 51, a power receiving-side rectifier circuit 54, and a charging circuit 55.

The power receiving-side resonance circuit 51 is disposed at a bottom of the vehicle 3 such that a distance from a road surface is reduced. The power receiving-side resonance circuit 51 has the same configuration as the power transmission-side resonance circuit 43, and has a resonator formed of a coil 52 and a capacitor 53. Various parameters of the coil 52 and the capacitor 53 (outer diameter and inner diameter of the coil 52, number of windings of the coil 52, capacitance of the capacitor 53, and the like) are determined such that a resonance frequency of the power receiving-side resonance circuit 51 coincides with a resonance frequency of the power transmission-side resonance circuit 43. When the amount of deviation between the resonance frequency of the power receiving-side resonance circuit 51 and the resonance frequency of the power transmission-side resonance circuit 43 is small, for example, when the resonance frequency of the power receiving-side resonance circuit 51 is within ±20% of the resonance frequency of the power transmission-side resonance circuit 43, the resonance frequency of the power receiving-side resonance circuit 51 need not necessarily coincide with the resonance frequency of the power transmission-side resonance circuit 43.

When an alternating-current magnetic field is generated by the power transmission-side resonance circuit 43 while the power receiving-side resonance circuit 51 faces the power transmission-side resonance circuit 43, vibration of the alternating-current magnetic field is transmitted to the power receiving-side resonance circuit 51 that resonates at the same resonance frequency as the power transmission-side resonance circuit 43. As a result, an induced current flows in the power receiving-side resonance circuit 51 by electromagnetic induction, and an induced electromotive force is generated in the power receiving-side resonance circuit 51 by the induced current. That is, the power transmission-side resonance circuit 43 transmits power to the power receiving-side resonance circuit 51, and the power receiving-side resonance circuit 51 receives power from the power transmission-side resonance circuit 43.

The power receiving-side rectifier circuit 54 is electrically connected to the power receiving-side resonance circuit 51 and the charging circuit 55. The power receiving-side rectifier circuit 54 rectifies alternating-current electric power supplied from the power receiving-side resonance circuit 51 and converts the alternating-current electric power into direct-current electric power, and supplies the direct-current electric power to the charging circuit 55. The power receiving-side rectifier circuit 54 is, for example, an AC/DC converter.

The charging circuit 55 is electrically connected to the power receiving-side rectifier circuit 54 and the battery 32. In particular, the charging circuit 55 is connected to the battery 32 via a relay 38. The charging circuit 55 converts the direct-current electric power supplied from the power receiving-side rectifier circuit 54 into electric power having a voltage level of the battery 32 and supplies the converted electric power to the battery 32. When the electric power transmitted from the power transmission device 4 is supplied to the battery 32 by the power receiving device 5, the battery 32 is charged. The charging circuit 55 is, for example, a DC/DC converter.

The vehicle controller 34 performs various controls of the vehicle 3. For example, the vehicle controller 34 is electrically connected to the charging circuit 55 of the power receiving device 5 and controls the charging circuit 55 to control the charging of the battery 32 by the electric power transmitted from the power transmission device 4. In addition, the vehicle controller 34 is electrically connected to the PCU 33 and controls the PCU 33 to control the transmission and reception of the electric power between the battery 32 and the motor 31. Further, the vehicle controller 34 controls the vehicle-side communication device 72.

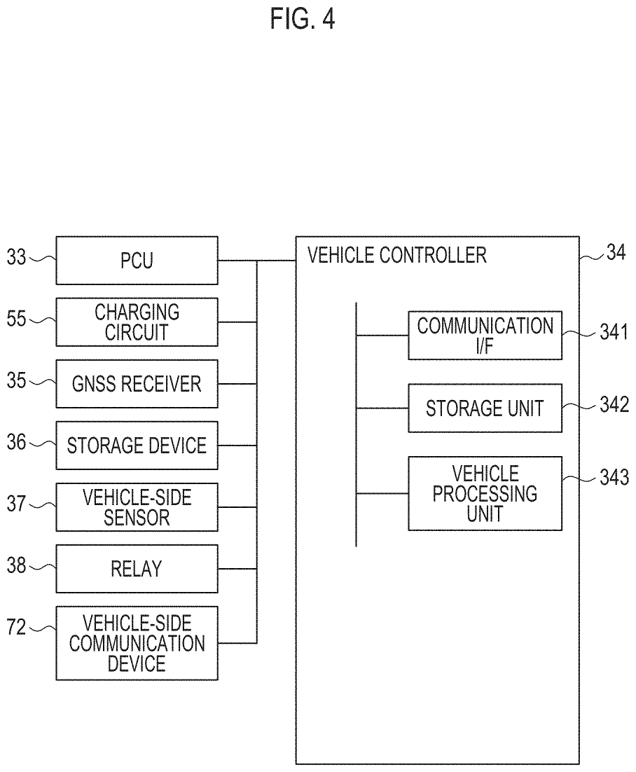

FIG. 4 is a schematic configuration diagram of the vehicle controller 34 and equipment connected to the vehicle controller 34.

The vehicle controller 34 includes a communication interface 341, a storage 342, and a vehicle processing unit 343. The communication interface 341, the storage 342 and the vehicle processing unit 343 are connected to one another via a signal line.

The communication interface 341 has an interface circuit for connecting the vehicle controller 34 to an in-vehicle network conforming to a standard, such as a controller area network (CAN). The vehicle controller 34 communicates with other equipment via the communication interface 341.

The storage 342 has a storage medium, such as an HDD, an optical recording medium, and a semiconductor memory, and stores various computer programs, data, and the like used for processing in the vehicle processing unit 343.

The vehicle processing unit 343 has one or a plurality of CPUs and peripheral circuits thereof. The vehicle processing unit 343 executes various computer programs stored in the storage 342 to comprehensively control the overall operation of the vehicle 3, and is, for example, one or more processors. For example, when detecting that the vehicle 3 has approached the electrified road, the vehicle processing unit 343, that is, the vehicle controller 34 starts transmission of the approach signal via the vehicle-side communication device 72 and controls the power receiving device 5 such that electric power can be received from the ground power supply device 2 when the vehicle 3 is traveling on the electrified road.

The vehicle 3 further includes a GNSS receiver 35, a storage device 36, a plurality of vehicle-side sensors 37, and the relay 38. The GNSS receiver 35, the storage device 36, the vehicle-side sensor 37, and the relay 38 are electrically connected to the vehicle controller 34 via the in-vehicle network.

The GNSS receiver 35 detects the current position of the vehicle 3 (for example, the latitude and longitude of the vehicle 3) based on positioning information obtained from a plurality of (for example, three or more) positioning satellites. The output of the GNSS receiver 35, that is, the current position of the vehicle 3 detected by the GNSS receiver 35 is transmitted to the vehicle controller 34.

The storage device 36 stores data. The storage device 36 includes, for example, an HDD, a solid state drive (SSD), or an optical recording medium. In the present embodiment, the storage device 36 stores map information. The map information includes information, such as installation position information of the ground power supply device 2, in addition to information on the road. The vehicle controller 34 acquires map information from the storage device 36. The storage device 36 need not include the map information. In this case, the vehicle controller 34 may acquire the map information from the outside of the vehicle 3 (for example, the server 1) via the vehicle-side communication device 72.

The vehicle-side sensor 37 detects the state of the vehicle 3. In the present embodiment, the vehicle-side sensor 37 includes, as a sensor that detects the state of the vehicle 3, a speed sensor that detects a speed of the vehicle 3, a battery temperature sensor that detects a temperature of the battery 32, a power receiving device temperature sensor that detects a temperature of various kinds of equipment (in particular, the power receiving-side resonance circuit 51 and the power receiving-side rectifier circuit 54) of the power receiving device 5, a battery current sensor that detects a charging current value and a discharging current value of the battery 32, a power receiving device current sensor that detects a current that flows through various kinds of equipment of the power receiving device 5, and a power receiving device voltage sensor that detects a voltage applied to various kinds of equipment of the power receiving device 5. The output of the vehicle-side sensor 37 is input to the vehicle controller 34.

The relay 38 is disposed between the battery 32 and the power receiving device 5 to connect and disconnect the battery 32 and the power receiving device 5. When the relay 38 is connected, the electric power received by the power receiving device 5 is supplied to the battery 32. However, when the relay 38 is disconnected, no current flows from the power receiving device 5 to the battery 32, so that the power receiving device 5 cannot substantially receive power.

Countermeasures Against Stealing and Leakage of Electricity

By the way, for the purpose of stealing of electricity (electricity theft), the power receiving device 5 may be installed on the ground power supply device 2 in a midnight time zone where it is difficult to see, or the power receiving device 5 may be installed on the ground power supply device 2 buried in a place where it is difficult to see. In addition, for example, the coating of the coil 44 of the ground power supply device 2 is damaged, whereby leakage of electricity may occur in the ground power supply device 2. Although it is desirable to enable early detection of stealing or leakage of electricity that has occurred in the ground power supply device 2, it is not practical to increase a frequency of maintenance and inspection of the ground power supply device 2 by a worker for early detection of stealing or leakage of electricity. The stealing of electricity also includes supplying power to a vehicle other than the vehicle 3.

Here, it is considered that the power supply amount of the ground power supply device 2 in which the stealing of electricity occurs is larger than the power supply amount of the surrounding ground power supply devices 2 in which the stealing of electricity does not occur by the amount of the stealing of electricity. Similarly, it is considered that the power supply amount of the ground power supply device 2 in which the leakage of electricity has occurred is larger than the power supply amount of the surrounding ground power supply devices 2 in which the leakage of electricity has not occurred by the amount of the leakage of electricity. Therefore, in the present embodiment, the occurrence of stealing or leakage of electricity in each ground power supply device 2 is detected based on the total power supply amount within a predetermined period of each ground power supply device 2.

FIG. 5 is a flowchart illustrating contents of processing according to the present embodiment executed between each ground power supply device 2 and the server in order to detect the occurrence of the stealing or leakage of electricity in each ground power supply device 2.

In Step S1, the power transmission controller 22 of the ground power supply device 2 determines whether or not it is a transmission timing of power supply information. The power supply information is information including ID information set for each ground power supply device 2, information on the total power supply amount within a predetermined period of the ground power supply device 2 (hereinafter, referred to as “total power supply amount information”), and information on an installation position of the ground power supply device 2 (hereinafter, referred to as “installation position information”). When a predetermined period has elapsed from a timing of the last transmission of the power supply information (Yes in Step S1), the power transmission controller 22 of the ground power supply device 2 determines that it is the transmission timing of the power supply information, and proceeds to the process of Step S2. On the other hand, when a predetermined period has not elapsed from the timing of the last transmission of the power supply information (No in Step S1), the power transmission controller 22 of the ground power supply device 2 ends the current process.

In Step S2, the power transmission controller 22 of the ground power supply device 2 transmits the power supply information to the server 1.

In Step S3, the server 1 stores the received power supply information in a power supply information database in the server storage 12. In this way, the power supply information of each ground power supply device 2 is aggregated in the server 1, and the aggregated power supply information of each ground power supply device 2 is stored in the power supply information database.

In Step S4, the server 1 refers to the power supply information database and, based on the installation position information in the power supply information received in Step S3, specifies the ground power supply device 2 installed near the ground power supply device 2 (that is, the ground power supply device 2 that has transmitted the power supply information in Step S2; hereinafter, referred to as a “transmission-source ground power supply device 2” as needed) that has transmitted the power supply information.

For example, the server 1 can simply specify the ground power supply device 2 that exists within a predetermined range centered on the transmission-source ground power supply device 2 as the ground power supply device 2 installed near the transmission-source ground power supply device 2. However, as will be described below, it is desired to specify, as the ground power supply device 2 installed near the transmission-source ground power supply device 2, the ground power supply device 2 that exists within a range in which the vehicle receiving the power supply from the transmission-source ground power supply device 2 is highly likely to travel, such as the ground power supply device 2 continuously disposed along a traveling lane in which the transmission-source ground power supply device 2 is installed.

In Step S5, the server 1 acquires, from the power supply information database, data of the total power supply amount within a predetermined period of each ground power supply device 2 specified in Step S4, that is, data of the total power supply amount of each ground power supply device 2 installed near the transmission-source ground power supply device 2, and sets a determination threshold value for determining whether the stealing or leakage of electricity has occurred in the transmission-source ground power supply device 2 based on the acquired data of the total power supply amount of each ground power supply device 2.

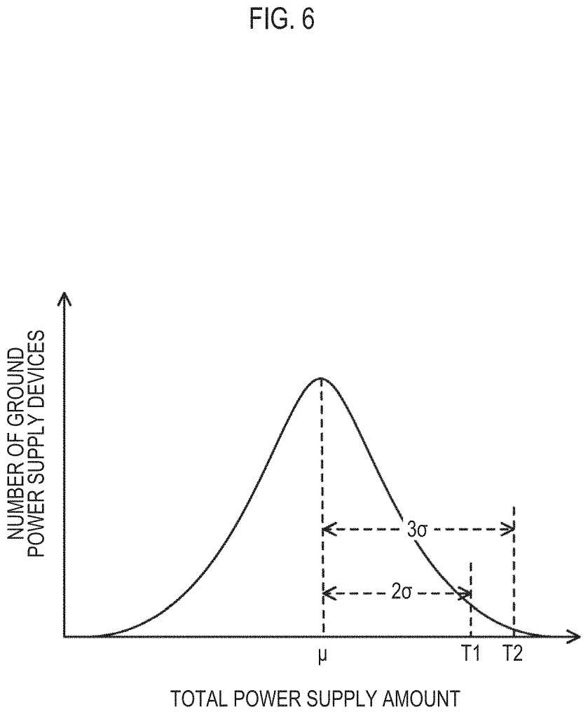

The determination threshold value can be set by using various known statistical methods based on the data of the total power supply amount of each ground power supply device 2 installed near the transmission-source ground power supply device 2. For example, since the data is considered to basically follow a normal distribution, assuming that an average value of the data is μ and a standard deviation of the data is σ, a value away from the average μ by a certain degree, such as a value T1 that is larger by 26 than the average μ or a value T2 that is larger by 36 than the average μ, can be simply set as the determination threshold value as shown in FIG. 6, for example.

As described above, in the present embodiment, the determination threshold value is set by using a statistical method based on the data of the total power supply amount of each ground power supply device 2 installed near the transmission-source ground power supply device 2. Here, the power supply amount to the vehicle 3 by each ground power supply device 2 is likely to be basically the same when the vehicle 3 is the same. Therefore, for example, when the stealing or leakage of electricity has occurred in one of the ground power supply devices 2, solely the power supply amount of the one ground power supply device 2 is larger than the power supply amount of other surrounding ground power supply devices 2.

Therefore, as described above, the ground power supply device 2 that exists within the range in which the vehicle 3 receiving the power supply from the transmission-source ground power supply device 2 is highly likely to travel is specified as the ground power supply device 2 installed near the transmission-source ground power supply device 2, whereby the determination threshold value can be set by using a statistical method based on the data of the total power supply amount within a predetermined period of each ground power supply device 2 that is highly likely to supply the power to the same vehicle 3. Therefore, an accuracy of the determination threshold value can be increased, and an accuracy of determining whether or not the stealing or leakage of electricity has occurred can be improved.

In Step S6, the server 1 determines whether or not the total power supply amount within a predetermined period of the transmission-source ground power supply device 2 is equal to or greater than the determination threshold value based on the total power supply amount information in the power supply information received in Step S3. When the total power supply amount within the predetermined period of the transmission-source ground power supply device 2 is equal to or greater than the determination threshold value (Yes in Step S6), the server 1 determines that there is a suspicion that the stealing or leakage of electricity has occurred in the transmission-source ground power supply device 2, and proceeds to the process of Step S7. On the other hand, when the total power supply amount within the predetermined period of the transmission-source ground power supply device 2 is less than the determination threshold value (No in Step S6), the server 1 determines that there is no suspicion that the stealing or leakage of electricity has occurred in the transmission-source ground power supply device 2, and ends the current process.

In Step S7, the server 1 transmits a power supply prohibition signal to the transmission-source ground power supply device 2. In this case, an external related organization (for example, a maintenance company of the ground power supply device 2 or a public organization, such as the police) may be notified of the occurrence of the stealing or leakage of electricity in the transmission-source ground power supply device 2 together with the position information of the transmission-source ground power supply device 2.

In Step S8, when the power supply prohibition signal is received, the power transmission controller 22 of the ground power supply device 2 prohibits the power supply to the vehicle 3, for example, by completely cutting the electric power supply from the electric power source 21 to the power transmission device 4.

Action and Effect

The server 1 according to the present embodiment described above includes: the server communicator 11 configured to communicate with a plurality of ground power supply devices 2 configured to transmit electric power to the vehicle 3 in a non-contact manner; the server storage 12 configured to store at least information on the total power supply amount within a predetermined period of the ground power supply devices 2; and the server processing unit 13 configured to, when a total power supply amount of one ground power supply device 2 is equal to or greater than a determination threshold value set based on data, determine that stealing or leakage of electricity has occurred in the one ground power supply device 2. The total power supply amount of the one ground power supply device 2 is a total power supply amount within a predetermined period of the one ground power supply device 2 among the ground power supply devices 2 and is received from the one ground power supply device 2 via the server communicator 11. The data is data of the total power supply amount within the predetermined period of the ground power supply devices 2 and is stored in the server storage 12.

With this, the server 1 can detect the occurrence of the stealing or leakage of electricity in each ground power supply device 2 periodically (every predetermined period), so that the ground power supply device 2 suspected of having the stealing or leakage of electricity can be detected early.

In particular, in the present embodiment, the server processing unit 13 is configured to set a determination threshold value by a statistical method using the data of the total power supply amount within a predetermined period of the ground power supply devices 2, which is stored in the server storage 12.

More specifically, the server processing unit 13 is configured to set the determination threshold value by the statistical method using data of the total power supply amount within a predetermined period of the ground power supply device 2 that exists within a range in which the vehicle 3 receiving power supply from the one ground power supply device 2 is highly likely to travel, out of the data of the total power supply amount within the predetermined period of the ground power supply devices 2, which is stored in the server storage 12. As an example of the ground power supply device 2 that exists within the range in which the vehicle 3 receiving the power supply from the one ground power supply device 2 is highly likely to travel, there is a ground power supply device 2 continuously disposed along a traveling lane in which the one ground power supply device 2 is installed.

The power supply amount to the vehicle 3 by each ground power supply device 2 is likely to be basically the same when the vehicle 3 is the same. Therefore, for example, when the stealing or leakage of electricity has occurred in one of the ground power supply devices 2, solely the power supply amount of the one ground power supply device 2 is larger than the power supply amount of other surrounding ground power supply devices 2. Therefore, the determination threshold value is set by using the statistical method based on the data of the total power supply amount within a predetermined period of each ground power supply device 2 that is highly likely to supply the power to the same vehicle 3, whereby an accuracy of the determination threshold value can be increased, and an accuracy of determining whether or not the stealing or leakage of electricity has occurred can be improved.

In the present embodiment, the server processing unit 13 is configured to, when determination is made that the stealing or leakage of electricity has occurred in the one ground power supply device 2, instruct the one ground power supply device 2 to prohibit power supply via the server communicator 11. With this, it is possible to prevent the stealing or leakage of electricity after the prohibition instruction.

The server communicator 11 is configured to communicate with an external related organization, and the server processing unit 13 is configured to, when determination is made that the stealing or leakage of electricity has occurred in the one ground power supply device 2, notify the external related organization that the stealing or leakage of electricity has occurred in the one ground power supply device 2 via the server communicator 11. With this, in a case where the stealing or leakage of electricity has occurred, appropriate follow-up measures can be taken.

Although the embodiments of the present disclosure have been described above, the above embodiments merely show a part of application examples of the present disclosure, and the technical scope of the present disclosure is not limited to the specific configuration of the embodiments described above.

What is claimed is:

1. A server comprising:
a communicator configured to communicate with a plurality of ground power supply devices configured to transmit electric power to a vehicle in a non-contact manner;
a storage configured to store at least information on a total power supply amount within a predetermined period of the ground power supply devices; and
one or more processors configured to, when a total power supply amount of one ground power supply device is equal to or greater than a determination threshold value set based on data, determine that stealing or leakage of electricity has occurred in the one ground power supply device, the total power supply amount of the one ground power supply device being a total power supply amount within a predetermined period of the one ground power supply device among the ground power supply devices and being received from the one ground power supply device via the communicator, the data being data of the total power supply amount within the predetermined period of the ground power supply devices and being stored in the storage.

2. The server according to claim 1, wherein the one or more processors are configured to set the determination threshold value by a statistical method using the data.

3. The server according to claim 2, wherein the one or more processors are configured to set the determination threshold value by the statistical method using first data, out of the data, and the first data is data of a total power supply amount within a predetermined period of the ground power supply device that exists within a range in which the vehicle receiving power supply from the one ground power supply device is highly likely to travel.

4. The server according to claim 3, wherein the ground power supply device that exists within the range in which the vehicle receiving the power supply from the one ground power supply device is highly likely to travel is a ground power supply device continuously disposed along a traveling lane in which the one ground power supply device is installed.

5. The server according to claim 1, wherein the one or more processors are configured to, when determination is made that the stealing or leakage of electricity has occurred in the one ground power supply device, instruct the one ground power supply device to prohibit power supply via the communicator.

6. The server according to claim 1, wherein:
the communicator is configured to communicate with an external related organization; and
the one or more processors are configured to, when determination is made that the stealing or leakage of electricity has occurred in the one ground power supply device, notify the external related organization that the stealing or leakage of electricity has occurred in the one ground power supply device via the communicator.
